(19) United States
(12) Patent Application Publication
(10) Pub. No.: US 2006/0098580 A1
(43) Pub. Date: May 11, 2006

(54) Apparatus and method capable of beam forming adjustments

(76) Inventors: Qinghua Li, Sunnyvale, CA (US); Xintian E. Lin, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/984,587

(22) Filed: Nov. 8, 2004

(51) Int. Cl. H04Q 7/24; H04J 3/14

(52) U.S. Cl. 370/245; 370/338

(57) ABSTRACT

An embodiment of the present invention provides a wireless communication system capable of beamforming adjustments, comprising a transmitter capable of transmitting beamformed data packets and a receiver capable of receiving the beamformed packets and detecting any failed beamforming packets addressed to the receiver and determining a reason for the failure, and wherein the receiver is capable of indicating to the transmitter a reason the failure. The receiver may further determine the reason for failure by checking crosstalk of beamed data streams and if the crosstalk is low and the lost data packet is sent by a beamforming mode, the receiver may send back a channel sounding packet in order to track the channel. Also, the receiver may further check the channel quality and select an appropriate data rate for the transmitter for feedback and may send a control packet back to the transmitter.

### BACKGROUND

Wireless communications has become prevalent throughout society creating the need for faster and more reliable wireless communication techniques. Although not limited in this respect, one such technique, 802.11n is designed to increase WLAN speeds to at least 100M bps for data and actual throughput rates. Unlike current ratified standards—802.11a, 802.11b and 802.11g—802.11n focuses on throughput at the MAC (media access control) interface, rather than as a signaling bit rate in the physical layer. This means the throughput rates will more likely match the highest-possible data rates. This standard may operate in the 5 GHz range along with 802.11a, although the present invention is not limited to these frequency ranges.

One technique used in 802.11n includes calibration and implicit feedback for closed loop multiple input multiple output (MIMO). One existing technique provides that when a beamformed data packet is not correctly received, the receiver doesn't send anything and the transmitter infers the packet loss after a short interframe space (SIFS) time. The transmitter retransmits the packets at a later opportunity. There may be several reasons for the packet loss. For example, the calibration may be obsolete; the selected data rate may be too high; the channel state information at the transmitter may be obsolete. Since the receiver doesn't send back any information for the transmitter to identify the reason, it may take a long time for the transmitter to resolve the problem. Similar problems exists in explicit feedback MIMO system, where transmitters needs to find out the cause of failed transmission: noise or beam forming error.

Thus, a strong need exists for an apparatus and method capable of improved wireless communication techniques that overcome the aforementioned shortcomings.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates two sequential packet losses due to noise and loss of channel tracking;

FIG. 2 illustrates packet losses due to obsolete calibration which takes a long time for the transmitter to realize;

FIG. 3 is an illustration of one embodiment of the present invention providing a solution to the packet losses illustrated in FIG. 1; and

FIG. 4 is an illustration of one embodiment of the present invention providing a solution to the packet losses illustrated in FIG. 2.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

Multiple-input multiple-output (MIMO) antenna technology is a promising candidate for IEEE 802.11n high throughput and 802.16d standard. It is understood that these standards are just a couple of many wireless communication techniques that are intended to fall within the scope of the present invention and any standards illustrated herein are intended to merely exemplify techniques which may obtain benefits by utilizing the present invention.

For the 802.11n wireless standard, a calibration and implicit feedback for closed loop Multiple-input multiple-output (MIMO) has been proposed and developed for beamformed data packets that have not been correctly received; however, the receiver does not send anything and the transmitter infers the packet loss after short interframe space (SIFS) time and retransmit sometime later. There may be several reasons for the packet loss. For example, the calibration may be obsolete or the selected data rate may be too high or the channel state information at the transmitter may be obsolete. Since the receiver doesn't send back any information for the transmitter to identify the reason, it may take a long time for the transmitter to resolve the problem.

In an embodiment of the present invention, response schemes utilized by a receiver when it fails to receive a packet are presented. First, inaccurate beamforming may be detected at the receiver by checking the crosstalk between the beamformed data streams. If the crosstalk level is high, there may be two reasons. Namely, the calibration or the channel state information may be obsolete. Since channel sounding is frequent as specified in 802.11n, it is not very likely the channel station information is obsolete. Therefore, the receiver will first assume the calibration is obsolete and send out a calibration initiator packet in order to reestablish channel reciprocity. Second, if the packet loss is due to the overestimated data rate, it is very helpful for the receiver to feedback the proper data rate to the transmitter. The receiver may send a packet with a specific data rate and the packet may be a CTS packet or a block ACK packet with no data packet sequence number.

Third, even if the packet is lost due to noise, the receiver should also send a packet back so that the channel state information can be tracked, and won't cause another packet loss due to inaccurate beamforming.

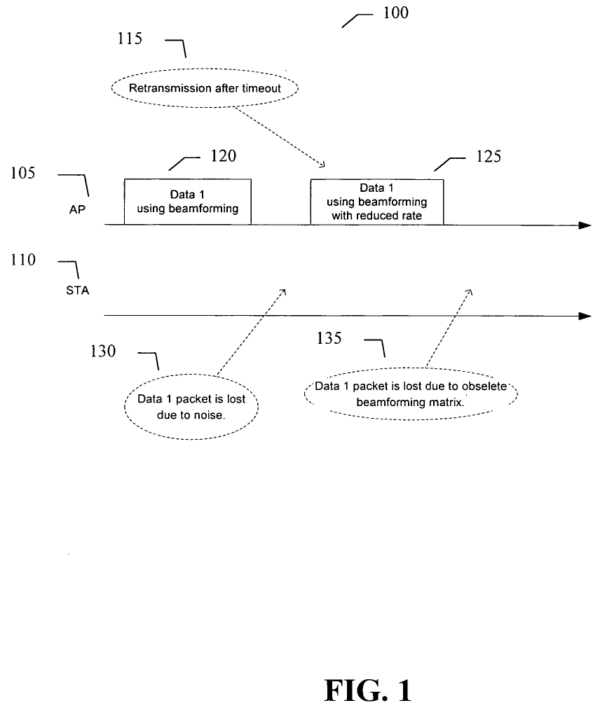

Turning now to the figures, FIG. 1 illustrates generally at 1000, where the channel is time varying. Access point (AP) 105 transmits data 1 to wireless statation (STA) 110 using beamforming at 120 and again transmits data 1 using beaming forming with reduced receive rate 125 due to data 1 packet being lost due to noise at 130. There are two packet losses 130 and 135. The first one 130 is due to noise. Since the receiver 110 (wireless station in this example) doesn't send anything, the transmitter 105 (Access Point (AP) in this example) loses track of the channel changes. This causes the second loss 135 of the retransmitted packet due to an obsolete beamforming matrix.

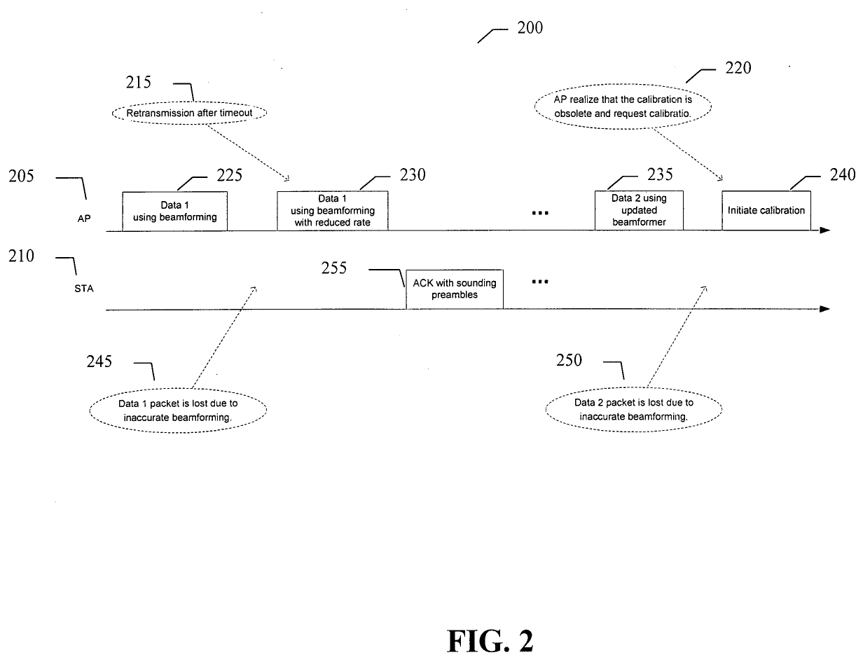

Turning now to FIG. 2, is another example where the calibration of the access point (AP) 205 is obsolete. The channel reciprocity between the uplink and downlink is spoiled by the obsolete calibration information. In an embodiment of the present invention, calibration is employed by the implicit feedback proposal to ensure the channel reciprocity. Without the present invention, the loss of reciprocity results in poor transmit beamforming and inaccurate beamforming increases the crosstalk between data streams and results in the loss of Data 1 packet 225 addressed to STA 210. Again, without utilizing the present invention, the station 210 doesn't send anything when Data 1 packet (Data 1 packet using beamforming shown at 225) is lost due to inaccurate beamforming 245. This creates a problem for the AP 205, which doesn't know its calibration is obsolete. The AP 205 assumes that the selected data rate was too high and caused the packet loss. The AP 205 then reduces the transmission rate and retransmits with reduced rate 230 the Data 1 packet. The packet is received due to the enhanced protection of the reduced modulation scheme, and an ACK packet with sounding preambles 255 is sent.

The AP 205 continues to send data packets using data rates lower than optimal, as shown with Data 2 using updated beamformer 235 with Data 2 packet lost due to inaccurate beamforming at 250 and thereafter AP 205 initiates calibration after AP 205 realizes that the calibration is obsolete and requests calibration.

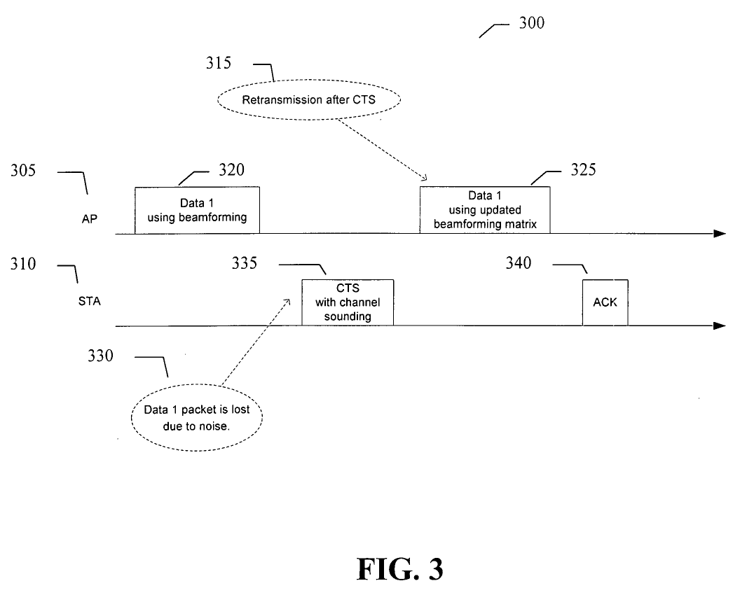

Turning now to FIG. 3, illustrated generally at 300 is an illustration of the system and method of the present invention provided by a wireless communication system capable of beamforming adjustments, comprising a transmitter, such as but not limited to, an access point (AP) 305, capable of transmitting beamformed data packets 320 and a receiver, such as but not limited to, a wireless station 310, capable of receiving the beamformed packets 320 and detecting any failed beamforming packets addressed to the receiver and determining a reason for the failure. For example, but not limited to, Data 1 packet could be lost to noise as seen at 330.

The receiver may be capable of indicating to the transmitter 305 a reason for the failure. The receiver 310 may determine the reason for failure by checking crosstalk of beamed data streams and if the crosstalk is low and the lost data packet is sent by a beamforming mode, the receiver sends back a channel sounding packet in order to reduce the crosstalk, such as clear to send (CTS) with channel sounding 335. The receiver may then further check the channel quality and select an appropriate data rate for the transmitter 305 for feedback and send a packet, such as a control packet back to the transmitter 305. Again, the control packet may be capable of containing channel sounding 335 preambles so that the transmitter 305 may keep track of the channel variation. At 325 Data using updated beamforming matrix provided by retransmission after CTS is transmitted with a return ACK 340 returned by the receiver 310.

In an embodiment of the present invention, the aforementioned may be accomplished by the receiver 310 acknowledging a packet, checking a “more data” field of the received packet and if there is a subsequent packet from the transmitter 305, the receiver 310 sends an acknowledgement with channel/train sounding preambles 335, and if no subsequent packets is received, no acknowledgement packet with channel/train preambles is sent.

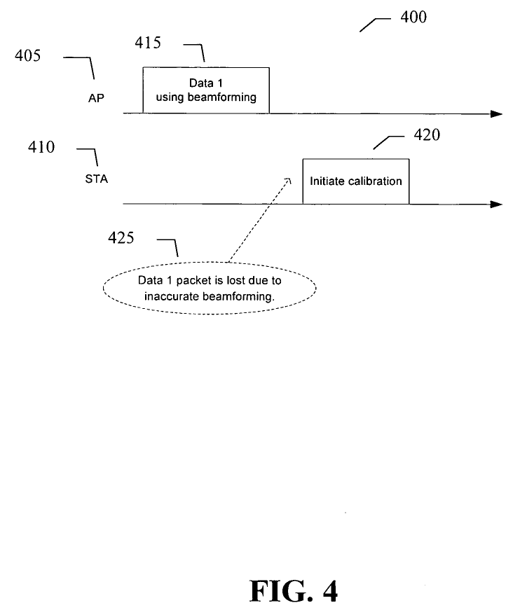

Turning now to FIG. 4, shown generally as 400, in another embodiment of the present invention, the transmitter 405 may transmit Data 1 using beamforming 415 and if the receiver 410 determines that the crosstalk is high and the Data 1 packet is lost due to the inaccurate beamforming, the receiver 410 may send back updated beamforming matrixes and may further recommends a transmit data rate to the transmitter. If the receiver 410 determines the reason for failure by checking crosstalk beam data streams and if it finds that the crosstalk is high, the receiver 410 may request calibration by sending a calibration initiator packet.

If the receiver 410 communicates with another device using a beamformed mode a short period prior and is sure that its calibration state is fine and its chains don't need to be calibrated, then it may only initiate a calibration process for the transmitter 410, thereby avoiding a full calibration that calibrates the chains on both the transmitter 405 and the receiver 410. Further, in the last packet sent by the receiver 410 during calibration, the receiver may recommend a transmit data rate to the transmitter 405.

Although the present invention is not limited in this respect, it is understood that as described above, the present invention enables both implicit feedback systems and explicit feedback systems. In implicit feedback, if a packet is corrupted, the receiver tests the cross talk and if it is low, may determine that the transmitter should reduce the date rate. Therefore it may send back channel sounding packets and suggest a date rate. If the cross talk is high, then the receiver may determine if the receiver has a recent calibration and if it has, then sending a Tx only calibration initiator. If a recent calibration has not occurred, then a full Tx/Rx calibration initiator may be sent. If desired, then a data rate recommendation may be added in the last packet. If a packet has not been corrupted a ACK may be sent.

In an explicit feedback system, if a packet is corrupted, the receiver tests the cross talk, and if it is low, determines that transmitter should reduce the date rate. Therefore it may send back a channel sounding packets (to update the channel info) and suggests a date rate. If the cross talk is high, then sent back is a new beam forming matrix which may include a suggested data rate. As with the implicit feedback system, if no packets are corrupted an ACK may be sent.

Yet another embodiment of the present invention provides a method of beamforming adjustments in wireless communication, comprising transmitting beamformed data packets by a transmitter, receiving the beamformed packets by a receiver and detecting any failed beamforming packets addressed to the receiver and determining a reason for the failure.

Also provided is an article comprising a storage medium having stored thereon instructions, that, when executed by a computing platform, results in beamforming adjustments in wireless communication, by transmitting beamformed data packets by a transmitter and receiving the beamformed packets by a receiver and detecting any failed beamforming packets addressed to the receiver and determining a reason for the failure. The article may further control the indicating to the transmitter by the receiver a reason the failure and the article may enable determining by the receiver the reason for failure by checking crosstalk of beamed data streams and if the crosstalk is low and the lost data packet is sent by a beamforming mode, sending back a channel sounding packet by the receiver in order to update the channel and suggest newer data rate.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless communication system capable of beamforming adjustments, comprising:
a transmitter capable of transmitting beamformed data packets;
a receiver capable of receiving said beamformed packets and detecting any failed beamforming packets addressed to said receiver and determining a reason for the failure.

2. The wireless communication system of claim 1, wherein said receiver is capable of indicating to said transmitter a reason said failure.

3. The wireless communication system of claim 1, where said receiver determines said reason for failure by checking crosstalk of beamed data streams and if said crosstalk is low and the lost data packet is sent by a beamforming mode, the receiver sends back a channel sounding packet in order to update the channel.

4. The wireless communication system of claim 2, wherein said receiver further checks the channel quality and selects an appropriate data rate for said transmitter for feedback and sends a packet back to said transmitter.

5. The wireless communication of claim 4, wherein said packet is a control packet.

6. The wireless communication system of claim 5, wherein said control packet is capable of containing channel sounding preambles so that the transmitter can keep track of the channel variation.

7. The wireless communication system of claim 5, wherein said control packet contains a field which recommends a data rate to said transmitter.

8. The wireless communication system of claim 5, wherein when said receiver acknowledges a packet, it checks a “more data” field of said received packet and if there is a subsequent packet from said transmitter, said receiver sends an acknowledgement with channel/train sounding preambles, and if no subsequent packets will be received no acknowledgement packet with channel/train preambles is sent.

9. The wireless communication system of claim 1, where said receiver determines said reason for failure by checking crosstalk beam data streams and if it finds that the crosstalk is high, said receiver sends a channel sounding packet.

10. The wireless communication system of claim 9, wherein said receiver also recommends a transmit data rate to the transmitter.

11. The wireless communication system of claim 1, wherein said receiver determines said reason for failure by checking crosstalk beam data streams and if it finds that the crosstalk is high, said receiver requests calibration by sending a calibration initiator packet.

12. The wireless communication system of claim 11, wherein if said receiver communicates with another device using a beamformed mode a short period prior and is sure that its calibration state is fine and its chains don't need to be calibrated, then said receiver only initiates a calibration process for the transmitter, thereby avoiding a full calibration that calibrates the chains on both said transmitter and said receiver.

13. The wireless communication system of claim 12, wherein in the last packet sent by said receiver during calibration, said receiver recommends a transmit data rate to said transmitter.

14. A method of beamforming adjustments in wireless communication, comprising:
transmitting beamformed data packets by a transmitter;
receiving said beamformed packets by a receiver and detecting any failed beamforming packets addressed to said receiver and determining a reason for the failure.

15. The method of claim 14, further comprising indicating to said transmitter by said receiver a reason said failure.

16. The method of claim 14, further comprising determining by said receiver said reason for failure by checking crosstalk of beamed data streams and if said crosstalk is low and the lost data packet is sent by a beamforming mode, sending back a channel sounding packet by said receiver in order to track channel information.

17. The method of claim 16, further comprising checking the channel quality by said receiver and selecting an appropriate data rate for said transmitter for feedback and sending a packet back to said transmitter.

18. The method of claim 17, wherein said packet is a control packet.

19. The method of claim 18, further comprising containing channel sounding preambles by said control packet so that said transmitter can keep track of the channel variation.

20. The wireless communication system of claim 18, further comprising recommending a data rate to said transmitter with a field contained within said control packet.

21. The method of claim 18, further comprising, when said receiver acknowledges a packet, it checks a “more data” field of said received packet and if there is a subsequent packet from said transmitter, said receiver sends an acknowledgement with channel/train sounding preambles, and if no subsequent packets will be received, no acknowledgement packet with channel/train preambles is sent.

22. The method of claim 14, further comprising determining by said receiver said reason for failure by checking crosstalk beam data streams and if it finds that the crosstalk is high, sending back a channel sounding packet by said receiver.

23. The method of claim 22, further comprising recommending by said receiver a transmit data rate to said transmitter.

24. The method of claim 14, further comprising checking crosstalk by said receiver to determine said reason for failure by beam data streams and if it finds that the crosstalk is high, said receiver requests calibration by sending a calibration initiator packet.

25. The method of claim 24, wherein if said receiver communicates with another device using a beamformed mode a short period prior and is sure that its calibration state is fine and its chains don't need to be calibrated, then said receiver only initiates a calibration process for the transmitter, thereby avoiding a full calibration that calibrates the chains on both said transmitter and said receiver.

26. The method of claim 24, further comprising, recommending a transmit data rate to said transmitter in the last packet sent by said receiver during calibration.

27. An article comprising a storage medium having stored thereon instructions, that, when executed by a computing platform, results in beamforming adjustments in wireless communication, by transmitting beamformed data packets by a transmitter and receiving said beamformed packets by a receiver and detecting any failed beamforming packets addressed to said receiver and determining a reason for the failure.

28. The article of claim 27, wherein said article further controls the indicating to said transmitter by said receiver a reason said failure.

29. The article of claim 27, further comprising said article determining by said receiver said reason for failure by checking crosstalk of beamed data streams and if said crosstalk is low and the lost data packet is sent by a beamforming mode, sending back a channel sounding packet by said receiver in order to track the channel.

30. A method of explicit feedback in a wireless communication system, comprising:
determining if a packet is corrupted and if so testing the cross talk; and
instructing the transmitter to reduce the date rate if said cross talk is low and sending channel sounding packets with a suggests a date rate.

31. The method of claim 30, further comprising:
determining if a recent calibration has occurred if the cross talk is high and if so sending a Tx only calibration initiator and if not then sending a full Tx/Rx calibration initiator.

32. The method of claim 31, further comprising adding a data rate recommendation in the last packet.

33. The method of claim 30, further comprising sending a ACK packet if no packets have been corrupted.

34. The method of claim 30, further comprising sending back a new beam forming matrix if the cross talk is high.

35. The method of claim 34, further comprising including a suggested data rate.
